(19) United States
(12) Patent Application Publication
(10) Pub. No.: US 2022/0143533 A1
(43) Pub. Date: May 12, 2022

(54) FILTER ELEMENT FOR A FILTER UNIT

(71) Applicant: Filtration Group GmbH, Oehringen (DE)

(72) Inventor: Thomas Gaugler, Oehringen (DE)

(21) Appl. No.: 17/611,043

(22) PCT Filed: Mar. 20, 2020
(86) PCT No.: PCT/EP2020/057785

§ 371 Date: Nov. 12, 2021

(30) Foreign Application Priority Data
May 14, 2019 (DE) 10 2019 207 003.5

(51) Int. Cl. B01D 29/11; B01D 29/15; B01D 29/58; B01D 29/90

(52) U.S. Cl. CPC B01D 29/111; B01D 29/15; B01D 2201/188; B01D 29/902; B01D 2201/184; B01D 29/58

(57) ABSTRACT

A filter element for a filter unit for filtering a fluid may include a filter element body. The filter element body may include at least one structural body and a support body. The structural body may have a filter structure which is permeable for the fluid. The filter structure may have a plurality of meshes/pores. The filter structure may be structured as a three-dimensionally interlinked lattice structure having a repeating regularity. The plurality of meshes/pores may be formed as a plurality of clear spaces by a plurality of lattice rods that are securely connected to one another. The support body may include a support structure that is permeable for the fluid. The structural body and the support body may each be produced via a 3D printing method. The structural body and the support body may be 3D printed from at least one of various materials and material compositions.

### CROSS-REFERENCE TO RELATED APPLICATIONS

This application claims priority to International Patent Application No. PCT/EP2020/057785, filed on Mar. 20, 2020, and German Patent Application No. DE 10 2019 207 003.5, filed on May 14, 2019, the contents of both of which are hereby incorporated by reference in their entirety.

### TECHNICAL FIELD

The present invention relates to a filter element for a filter unit for filtering a fluid.

### BACKGROUND

Filter elements are used in corresponding filter units for filtering solid particles out of liquids, which have a filter body with a filter material for particle filtration. These filter materials have filter structures made from suitable materials. For example, filter structures made from woven-fabric and/or cellulose materials are used, which have limited filter properties for material reasons and can only be brought into complex shapes to a limited extent. Filter elements of this type have a predetermined and non-changeable filter characteristic, which only permits an optimization to the fluid to be filtered to a limited extent.

A filter material for sorption filtration with a filter structure consisting of particles, which is formed by a fibrous three-dimensional framework of composite fibres, is known from DE 43 44 805 C2. Apart from a structural component, these composite fibres have a further first component with a melting point approximately 20° C. lower than the structural component, so that in the event of a corresponding thermal treatment, the first component can melt and thus intersecting or touching structural components can connect to one another.

A ceramic filter element for filtering molten metals is known from DE 20 2017 104 240 U1. The filter element has a 3D printed uniform flat structural body for filtering the molten metal and a 3D printed uniform support body, which circumferentially encloses the structural body in a closed manner and as a result virtually forms a cage for holding the structural body.

The fibrous three-dimensional framework is composed of structural fibres of various dimensions, particularly different fibre thicknesses, which all have the previously mentioned property of a further first component and are connected to one another by the thermal treatment mentioned. The fibrous three-dimensional framework of composite fibres therefore consists of differently dimensioned structural fibres, which are more or less freely arranged with respect to one another and connected, but do not have any uniform repeating structures. Here, the thicker structural fibres take on a type of supporting effect for the filter structure, wherein the thinner structural fibres take on the actual important filter function. In this case, it is possible that both the thicker and the thinner structural fibres consist of the same material. To produce this filter structure, finer structural fibres are dispersed into a framework made from coarser structural fibres, for example by hydroentangling or by air entangling. Alternatively, a finer woven fabric can be formed from thermoplastic structural fibres in order to subsequently incorporate a woven fabric with coarser structural fibres, to achieve a filter stability.

Furthermore, cavities are created by the connected structural fibres, in which functional particles for realizing the sorption effect are trapped and which are themselves formed by the thermoplastic composite fibres and a second low-melting component. Thus, during the thermal connection of the structural fibres, not only the irregular and free connection of the structural fibres, but functional deposits are created in the cavities due to differently melting components. Similarly to long-chain molecules, very coarse fibrous frameworks, similar to a non-woven fabric, are produced in this manner. To achieve particular effects, the structural fibres may consist of crimped fibres, which can be processed analogously to previously described approaches. This fibrous structure may have a higher density, but also a high inner movability and therefore effect a deformability of the framework. The functional particles created during the thermal treatment may for example consist of activated carbon, wherein other functional particles, such as for example silicon dioxide, zeolite clay, aluminium oxide and others, may also be created and embedded.

A method for printing a tissue construct with embedded vasculature is described in WO 2015/069619 A1. Here, a tissue construct produced by means of a 3D printing method comprises one or more tissue patterns, wherein each tissue pattern comprises a multiplicity of cells of one or more predetermined cell types. A network of vascular channels penetrates the one or other tissue patterns, wherein these passages can be introduced into the filaments used there, even during the production method of the printing.

An extracellular matrix composition at least partially surrounds the one or the plurality of tissue patterns and the network of vascular channels. In the 3D printing method used here, with respect to materials, the same and also different filaments may be used, wherein these filaments can be mixed during the 3D printing process when using special nozzles. Also, filler materials, such as hardeners, adhesives, etc. may be added here. To some extent, particular filler materials are already introduced and stored as homogeneous admixtures or as a constantly available admixture inside the filaments.

### SUMMARY

The present invention is concerned with the problem of specifying an improved embodiment for a filter element for particle filtration, which in particular stands out due to a high robustness and high filtering effect and due to a high deep loading capacity for satisfactory stability.

This problem is solved according to the invention by means of the subject matter of the independent claim(s). Advantageous designs are the subject matter of the dependent claim(s).

According to the invention, a filter structure by means of a three-dimensionally interlinked lattice structure is used for this, which is preferably completely produced by a 3D printing method. In this 3D printing method, filaments are melted and applied via nozzles in layers onto a support or built up along a support, wherein the printed filter element can consist of various filaments and various filament materials. Here, the filament may for example be a wire-shaped endless material with specific additives, wherein instead of the wire-shaped filament, a powdered, granular or liquid material can also be used for processing in the printing nozzles. This 3D printing method also makes it possible to produce complicated shapes for the filter element, in which undercut shapes, among others, are also possible. Likewise, this filter element may have very complicated shapes that are joined to one another, which means a maximum use of the available installation space for the filter element.

Also, the design of the filter unit can therefore take place under optimum use of the installation space available for the filter unit and enable geometric designs of filter units that could not hitherto be produced.

According to the invention, a support body is printed by means of this 3D printing method as support or support framework, which supports one or more structural bodies, which function as the actual filter, and therefore impart a dimensional stability to the entire filter element. This support body may be contacted at its outer and at its inner side by at least one structural body, wherein the structural bodies, which may be designed to be filigreed and less dimensionally stable compared to the support body, are kept stable in terms of their position and shape by the support body, due to the contact with the support body.

The structural bodies and the support body may here expediently be produced cohesively in each case from one piece, wherein designs made from individual parts for later construction are also possible. Here, the structural bodies have a three-dimensionally interlinked lattice structure, which consists of regularly repeating arrangements of rod elements. In this case, the rod elements are arranged at predetermined three-dimensional angles such that the lattice structure is created and three-dimensionally repeating clear spaces, what are known as meshes/pores, are likewise formed. These meshes/pores may have edge lengths of 0.05-15 mm, particularly 0.1-10 mm, specifically for filtering liquid fluids, wherein the actual edge lengths and the mesh and pore dimensions determined as a result are optimally adapted to the fluid to be filtered. Here, particular value is accorded to the through-flow rate of the fluid and the resultant pressure difference from the fluid entering into the filter element to the fluid exiting, so that the filtering effect is maximized and a possible heating of the through-flowing fluid is kept low. During the filtering of gaseous fluids, the edge lengths of the meshes/pores is preferably designed in the range 0.1-40 mm, particularly 4-20 mm. Due to the choice of the mesh and pore sizes adapted to the fluid to be filtered, the filter elements produced by means of the 3D printing method can have filter areas that are doubled compared to the filter inserts in common use today.

The filaments used during the 3D printing of the structural bodies may contain filler materials such as stabilizers, adhesives or else catalytically active materials which are embedded in the filaments during the creation of the lattice structures. Of these specially embedded materials, during printing of the rod elements, the catalytically active materials may for example be deposited in such a manner that the same collect in the clear spaces of the meshes/pores and can there carry out their specific catalytic function in contact with the fluid to be filtered. Of course, further suitable methods, such as for example melting of certain materials or others are possible for introducing these into the meshes/pores.

Here, the fluids to be filtered often show a coalescing effect (hydrophobic/oleophobic), in which the portions of the fluid to be precipitated/filtered out and/or particles are brought together as contaminant portions and shaped to form larger particles/drops, which are then precipitated out by the actual filtering effect of the filter element.

Particularly advantageous is an embodiment, in which the respective structural body and the support body are 3D printed from various materials and/or from various material compositions. As a result, the materials can be adapted to the different functions of the two components, in order to improve the respective functionality.

The respective structural body and the support body can expediently be 3D printed from plastic and/or from plastic material in each case. Particularly fine structures can be realized in this case. In addition, the filter element is comparatively inexpensive as a result.

An embodiment is advantageous, in which the structure of the support body has a cell structure or is formed by such, wherein this cell structure has passages formed by cells. In other words, the cells are configured to be open or permeable. In addition, it may well be provided that the meshes/pores of the respective structural body are smaller than the cells or the passages of the support body. The functionalities of the structural body and support body are improved as a result. The smaller meshes/pores improve the filtering effect. The larger cells increase the stability, particularly if that is accompanied by an increased thickness of the lattice rods involved. Accordingly, it may in particular be provided that cell rods for constructing the cell structure have a larger cross section than lattice rods for constructing the lattice structure.

According to a development, the cells or the passages of the support body are at least twice or five-times or ten-times larger than the meshes/pores of the respective structural body. Additionally or alternatively, the cell rods of the cell structure may have a cross section twice or five-times or ten-times larger than the lattice rods of the lattice structure. The functionalities of the structural body and support body can be improved as a result.

Particularly advantageous is an embodiment, in which the structure of the support body has a cell structure, which has passages formed by cells, wherein a portion of the lattice rods of the lattice structure penetrate into the passages of the cell structure or penetrate through the same. The elements of the lattice structure and the cell structure interact as a result. On the one hand, this enables a very compact design, as the structural body and support body more or less penetrate one another. On the other hand, a certain fixing of the structural body on the support body can be realized as a result, which improves the supporting effect thereof.

According to a development, it may be provided that a portion of the lattice rods of the lattice structure penetrate into the passages of the cell structure or penetrate through the same in such a manner that the lattice structure is positively fixed to the cell structure. In this case, it may in particular be provided that the lattice rods do not or only loosely touch the cell structure. Thus, the lattice rods remain movable with respect to the cell structure. Alternatively, materially-bonded connections, particularly fusion joints, may also be present at the contact points, depending on the printing method. Due to the positive engagement, the respective structural body can easily be stabilized by the support body.

As described previously, coaxially concentrically arranged structural bodies with a lattice structure can for example be used outside and/or inside the support body. In order to increase the dimensional stability of the structural bodies, these may be connected to the support body and also to further structural bodies during the 3D printing method by adhesive contained in the filaments or an additionally supplied adhesive. Also, the 3D printing method offers the possibility of placing the connecting rod elements in such a manner with respect to one another between the support body and the structural bodies or between the individual structural bodies, that the same are penetrated by these rod elements at least to some extent. As a result, a particularly high strength and connection of the bodies to one another is achieved. These connecting rod elements may consist of the same material as the structural bodies or the support body, wherein to increase the strength, the connecting rod elements preferably consist of a suitable material of higher strength. Also, these connecting rod elements may have a shape, thickness and/or geometric connecting structures for the structural bodies different from the lattice structure of the structural bodies. Thus, one or more structural bodies may be arranged at the outer region of the support body, in which the connecting rod elements run both inside the structural bodies and on the outer regions of the structural bodies.

A further embodiment according to the invention may consist in the three-dimensionally interlinked lattice structures having abrupt or continuous transitions of variously sized lattice structures and thus the permeability and the filter function can be changed or adapted. This takes place for example as a function of the flow function and/or the distribution of particle sizes to be filtered, which leads to a considerable increase of the effectiveness of the filter element. With the same change in behaviour, an abrupt and/or continuous change of the material of the interlinked lattice structures can also take place. These previously described possibilities of changes relate not only to the specific distribution of the lattice structures and materials of a structural body, but rather can also take place in the case of adjacent structural bodies, so that a plurality of outer and/or inner structural bodies arranged around a support body may have a multiplicity of changes of the lattice structures and the materials. All of these changes can of course take place in a continuously fluid manner or abruptly in sections.

For all of these variations, it is likewise possible that in the case of adjacent structural bodies, which are for example arranged substantially parallel or coaxially concentrically, a fluid connection transition with changing lattice structures and/or materials takes place with respect to the contact regions thereof. Thus, for example, the inner region of a structural body which is arranged outside is in direct contact with the outer region of a structural body which is arranged inside. The previously described connections of both structural bodies may take place in this region. The same is true analogously for structural bodies arranged in the inner region of the support body. Also, it is possible that the inner and outer structural bodies including the previously described changes can be realized together with the support body as a one-piece component.

The support body takes on the support function of the entire filter element and is therefore designed to be particularly stable. To this end, it is possible that a filament with higher strength is used during the 3D printing method of the support body. Furthermore, the dimensions and the shape of the support body are adapted to this supporting function by more strongly dimensioned geometric designs, particularly by cell structures. Thus, according to the invention, shapes such as for example a polygonal cell structure, preferably as a hexagonal honeycomb structure with considerably reinforced wall strength can be used during the shaping of the support body. The lattice structures used may have a considerable dead load caused by their dimensions and by the mesh density thereof, which, in the case of a plurality of parallel adjacent lattice structures, could not be supported by the same themselves and their interaction. Therefore, the requirements on the support body are to be specified in accordance with this loading and additionally to be adapted to the acting forces of the through-flowing fluid, which takes place by means of the shaping and the dimensioning of the support body and the geometry thereof. The support body and the structural bodies may to this end already be connected together and printed together. Individually printed support bodies and structural bodies, which are subsequently joined together and are adhesively bonded in this case for example, are possible as a further production method.

According to the invention, flow guidance elements, what are known as guide bodies or flaps, can be used as a further design. The 3D printing method used in the production of the support body and the structural bodies first enables guide bodies of this type both at the outer regions of the structural bodies and inside the structural bodies in any desired number and shape. Here, the guide bodies may have a wide range of geometric shapes, wherein these always fulfil the task of steering the fluid in its direction of flow in a targeted manner, however. A guide body of this type may therefore be used in a shovel-shaped manner, in a stepped manner or as a wound surface, wherein designs in a cubic shape are also conceivable for creating a flow resistance for swirling the fluid or for changing the dynamic pressure. The guide bodies can here be arranged in such a manner inside the lattice structures of the structural bodies, that the same can be penetrated by the rod elements of the lattice structure in any desired three-dimensional arrangement and number. Also, it is possible in the case of the common printing of structural bodies and/or support body, that these guide bodies are arranged and realized overlapping through a plurality of structural bodies. Due to this overlapping connection of the structural bodies/support body, an additional stiffening of the whole printed filter unit is achieved. In this manner, regions of the filter elements, which hitherto showed an unfavourable throughflow and the filtering effect of which is limited, can also be used optimally for filtering the fluid. For the same dimensions of the filter element, the same exhibits a considerable increase of filter effectiveness. Furthermore, it is additionally possible due to the use of the guide bodies, due to the targeted steering of the fluid, in the event of corresponding contaminants, to supply the fluid to a predetermined region of the filter element with filtering effects that are particularly suitable. In the case of a corresponding arrangement of the guide bodies in the supply region of the filter element, that is to say upstream of the inflow of the fluid into the structural body, a cyclone effect can be generated by the guide bodies, in the case of which the fluid is swirled circularly upstream of the structural body. Due to this effect, coarser and heavier contaminant particles collect at the housing wall, so that these cannot even penetrate into the filter. These coarser contaminant particles are guided along the housing wall to a suitable collection point, where the same can also be removed. This prior sorting of possible coarser contaminant particles enables a considerably longer operating time of the filter element. In this manner, the fluid can therefore be steered in a targeted manner through a plurality of sections/regions of the filter and thus optimally filtered.

According to an advantageous application, the filter element can be configured as a ring filter element, in which the respective structural body and the support body form an annular ring filter body or at least an annular part thereof, wherein the filter element or the ring filter element in addition has two end plates, which are respectively arranged at an axial end of the ring filter body.

In other words, a ring filter element according to the invention has an annular ring filter body, which is formed at least partially by a filter element of the previously described type. Accordingly, the respective structural body and the support body are configured to be annular, particularly cylindrical. In addition, the ring filter element has one end plate in each case at the axial ends of the ring filter body. Preferably, the ring filter body consists exclusively of the annularly configured filter element, as the annular filter element body has sufficient stability, due to the support structure, for certain applications, in which for example low to medium differential pressures occur between raw side and clean side. In other applications, in which for example high differential pressures occur between raw and clean side, the ring filter body may additionally be equipped with an inner frame and/or with an outer frame, on which the annular filter element or the annular filter element body thereof is radially supported.

In this case, at least one of the end plates can expediently be configured as an open end plate and have a central passage opening. The other end plate may, depending on the type of application of the ring filter element, likewise be configured as an open end plate or else as a closed end plate, which axially closes an interior enclosed by the ring filter body. The end plates can expediently be printed onto the ring filter body by means of 3D printing. The end plates may in this case consist of a different material, particularly of a different plastic than the respective structural body and the support body. Furthermore, it is conceivable to produce the end plates and the support body from the same material.

One design according to the invention is to be seen as a development in the function of individual structural bodies. Here, for example, the outermost and/or innermost structural bodies can no longer be constructed as a lattice structure, but rather are printed as solid bodies and thus as housing wall constitute the geometric boundary of the filter unit itself. As higher strength requirements are placed on a housing, a suitable material for that can be used as filament in the case of common structural body and housing or separately printed housing. Also, it is conceivable that to achieve this higher strength, particular materials are additionally supplied to the filament during 3D printing at the moment of printing.

Inside this housing wall, the filter element may be designed in the conventional, previously described arrangement, wherein a fixed connection may exist between the lattice structure of an inner structural body and the interior of the printed housing wall. Of course, the housing wall may be realized and printed separately from the inner adjacent structural body, wherein the actual filter element then subsequently has to be introduced into the housing and fixed there. This may for example take place by means of limit stops which are used as an insertion boundary, wherein the filter element is pushed in up to these limit stops and is subsequently securely connected to the housing in a positionally fixed manner by a suitable method, for example a thermal melting method or adhesive bonding. Of course, fastening methods that can be separated again, such as for example screwed connections, clamping rings, clips or others, can also be used.

The housing which is printed in this manner and equipped with a filter element may have delimiting elements in the form of fastening flanges for creating a complete filter unit. In the case of these fastening flanges, fastening holes and inlet and outlet openings are also introduced for example at the same time during printing. In order to also enable replaceability of the filter element here, it is conceivable that a fastening flange is connected to the housing in a detachable manner. Thus, the filter element that is introduced in a removable manner can be replaced, whilst the housing can be reused. Of course, a complete replacement of the filter unit is also possible.

In the case of the replaceable removable filter unit, both 3D printed components and contemporary components produced in a standard manner may be used in combination.

Further important features and advantages of the invention result from the dependent claims, from the drawings and from the associated description of the figures on the basis of the drawings.

It is understood that the previously mentioned features and the features which are still to be explained in the following, can be used not only in the respectively specified combination, but also in other combinations or alone, without departing from the scope of the present invention.

Preferred exemplary embodiments of the invention are illustrated in the drawings and are explained in more detail in the following description, wherein identical reference numbers refer to identical or similar or functionally identical components.

### BRIEF DESCRIPTION OF THE DRAWINGS

In the figures, in each case schematically

FIG. 1 shows a hollow cylindrical filter element constructed from support body and structural bodies,

FIG. 2 shows a hollow cylindrical support body with cell structure,

FIG. 3 shows a hollow cylindrical structural body with a three-dimensionally interlinked lattice structure made from rod elements,

FIG. 4 shows a hollow cylindrical filter element constructed from support body and structural bodies with a plurality of sections of different lattice structures,

FIG. 5 shows a hollow cylindrical filter element constructed from support body and structural bodies having flow guidance elements/guide bodies arranged inside and outside the lattice structure,

FIG. 6 shows a 3D printed filter unit consisting of housing, flanges and filter element.

### DETAILED DESCRIPTION

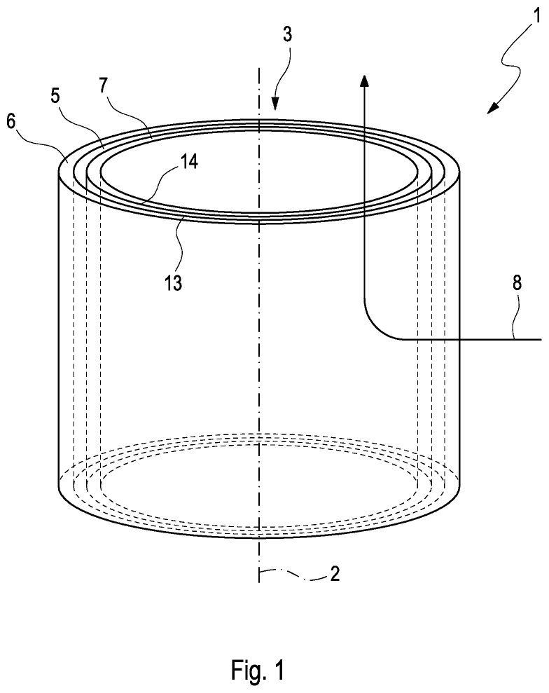

FIG. 1 shows a cylindrical filter element 1, the filter element body 3 of which is constructed from a support body 5 and from structural bodies 6, 7. In the case of the filter element 1, a corresponding coaxially and concentrically positioned hollow cylindrical structural body 6, 7 is arranged both on the inner region 14 and on the outer region 13 of the support body 5. A throughflow 8 of the fluid through the filter element 1 takes place here for example from the outside of the hollow cylindrical filter element 1 into the inner region of the hollow cylindrical filter element 1, whereupon the fluid is then guided further substantially parallel to the central axis 2. Of course, it is possible that instead of the hollow cylindrical filter element 1, filter elements 1 with structural bodies 6 and support bodies 5 in any desired geometric configuration may be used. Here, flat and/or cubic filter elements 1 are preferably used.

The outer structural body 6 is constructed as a three-dimensionally interlinked lattice structure 15 and is produced by means of a 3D printing method and is aligned orientated substantially parallel to the support body 5. The inner region 19 of the outer structural body 6 is in direct contact in certain regions with the outer region 13 of the support body 5 and is securely connected to the support body 5 in this contact region. This connection can take place by means of adhesive bonding of the contact region or by a materially-connected method of the contact regions. A further connection possibility of both bodies 5, 6—not illustrated in the figures—consists in the three-dimensionally interlinked lattice structure 15, which consists of rod elements 16, engaging using the rod elements 16 through the structure of the support body 5 and in this manner producing the connection of both bodies 5, 6.

As the inner region 19 of the outer structural body 6 is in contact with the outer region 13 of the support body 5, the analogous consideration applies to the outer region 18 of the lattice structure 15 of the inner structural body 7 and the inner region 14 of the support body 5, which is contacted at least in certain regions. Likewise, the three-dimensional interlinking of the rod elements 16 through the cell structure 10 of the support body 5 to connect both bodies 5, 7 is possible, wherein the cell structure 10 has a three-dimensional honeycomb structure 11, but may also have other shapes of any type.

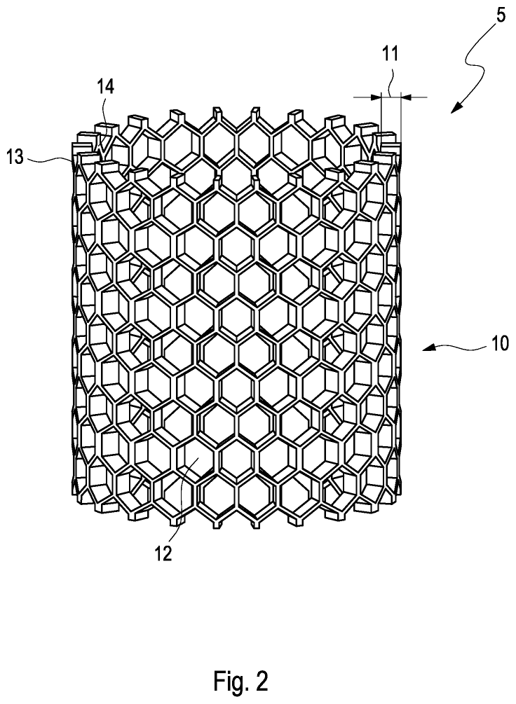

In FIG. 2, the interlinking and the mutual dimensionally stable connection of both bodies 6, 7 takes place by the engagement of the rod elements 16 of the lattice structure 15 through cells of the cell structure 10 of the support body 5, wherein the engagement at the support body 5 takes place through the clear space of the cell structure 10 or through the walls of the cell structure 10. As the support body 5 must hold and support a plurality of lattice structures 15 as support body for example and additionally must also absorb the forces arising due to the flowing fluid, the support body 5 is realized in a very stable shape. In the example shown, the support body 5 has a honeycombed structure, namely the cell structure 10, which has a larger material strength and wall strength 11 of the honeycomb structure 10 for the purpose of supporting forces. This means that rod-shaped cell rods of the cell structure 10 have a larger cross section than the lattice rods 16 of the lattice structure 15. It is also possible that when printing the support body 5, a filament material with higher strength is used and/or during the 3D printing process of the cell structure 10, particular strength-increasing material constituents are introduced into the melt of the filament. The choice of a possible cell structure 10, here a hexagonal honeycomb structure 10, particularly beneficially supports the forces and at the same time creates passages 12 which are sufficiently large and regular for the through-flowing fluid and the rod elements 16 running through these passages 12, which are used as connections between the support body 5 and the outer structural body 6, or as a connection of an inner structural body 7 to the outer structural body 6 through the support body 5. The rod elements 16 protruding through the passage openings 12 of the support body 5 may run directly through the passage opening 12 and/or penetrate regions of the honeycomb structure 10 and are thus securely connected to the same. This penetration of the rod elements 16 and the cell structure 10 additionally reinforce the connection.

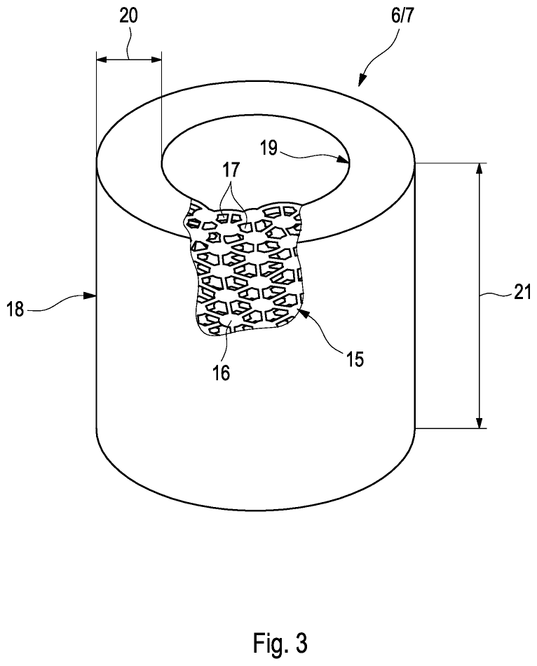

A hollow cylindrical structural body 6, 7 with a lattice structure 15 that is constructed in a three-dimensionally interlinked manner from rod elements or lattice rods 16 is depicted in FIG. 3. The rod elements 16 are here arranged combined and interlinked stellately and radially in a multiplicity of arrangements that repeat in such a manner. The hollow cylinder depicted here shows this interlinked structure in terms of its longitudinal extent 21 and in terms of its width 20, so that a three-dimensionally interlinked, hollow cylindrical structural body 6, 7 is created.

Due to the three-dimensionally interlinked lattice structure 15, the stellately arranged rod elements 16 create clear spaces, which are arranged and orientated in such a manner as meshes 17 or pores 17 that the fluid to be filtered can flow through the structural bodies 6, 7 optimally. Contaminants are left behind in the meshes/pores 17 or at the rod elements 16 in this case, wherein the structural bodies 6, 7 filling with contaminants ensure a satisfactory throughflow 8 of the structural body 6, 7 for a long time due to the large number of meshes/pores 17, without the increasing dynamic pressure when flowing through 8 the structural body 6, 7 reaching critical values. On the inner 14 or outer region 13 of the structural body 6, 7, the lattice structure 15 is provided with an adhesive for connection to further structural bodies 6, 7 that are arranged coaxially inside one another, preferably concentrically. This adhesive may for example have been positioned in these regions as filler material with the filament during the printing process, wherein a subsequent adhesive coating of this inner 14 and outer region 13 is also possible. Likewise, it is possible that substances are introduced into the lattice structure 15 during the 3D printing method with the filaments or as additionally supplied material, which substances collect in a concentrated manner in the meshes/pores 17 in order to create specific reactions and/or catalytic effects of the fluid to be filtered there. These may inter alia be suitable for permanently adhering certain contaminants to the rod elements 16 and/or joining/linking substances present in the fluid to one another and these can therefore be filtered out as contaminant by the lattice structure 15.

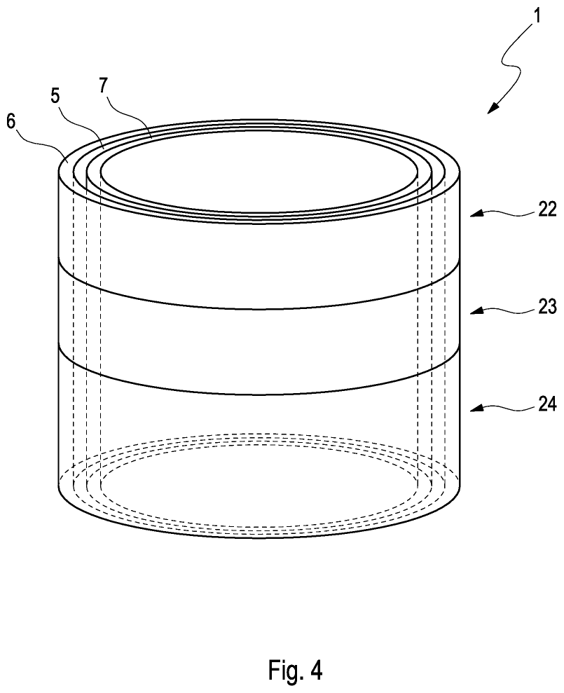

A hollow cylindrical filter element 1 is illustrated in FIG. 4, which is constructed from support body 5 and structural bodies 6, 7 with a plurality of sections 22, 23, 24 of different lattice structures 15 of the structural body 6, 7. The structural bodies 6, 7 are here arranged coaxially, particularly concentrically inside one another, wherein the support body 5 is positioned between the two structural bodies 6, 7.

The structural bodies 6, 7 may for example be divided in terms of their longitudinal extent 21 into a plurality of sections, here into three sections 22, 23, 24. In these divisions, the sections 22, 23, 24 for example consist of different materials and/or the lattice structure 15 differs in terms of its number of rod elements 16 realized or the number of meshes/pores 17. Thus, it is possible that in a first section 22, a coarse-meshed lattice structure 15, which consists of few rod elements 16, is depicted and the section 23 adjoining this section 22 has a finer lattice structure 15, with a plurality of shorter rod elements 16 than are present in section 22.

Analogously, the subsequent section 24 may have a further, clearly differing lattice structure 15.

The transitions between the individual sections 22, 23, 24 and the different lattice structures 15 may here take place abruptly or continuously smoothly. This division into sections of a structural body 6, 7 can, as previously mentioned, be divided into further concentrically arranged structural bodies 6, 7 and/or also into radial sections that are not depicted here. Here also, coarse to less coarse lattice structures 15 may follow and these may of course also have abrupt and/or continuously smooth transitions. In this case, it is not important whether the structural bodies 6, 7 exist as individual lattice structures 15 or consist of lattice structures 15 that are connected together and thus of a plurality of structural elements 6, 7 that are connected.

The division into different sections 22, 23, 24, wherein the sections 22, 23, 24 can be independent of one another and differently dimensioned is important for optimum filtering of the fluid. Thus, for example, fluid can flow optimally through regions of the structural body 6, 7, through which fluid flows less intensively, due to a change of the dynamic pressure by means of coarser or smaller meshes/pores 17 and less or more rod elements 16, and as a result the regions filter the fluid efficiently.

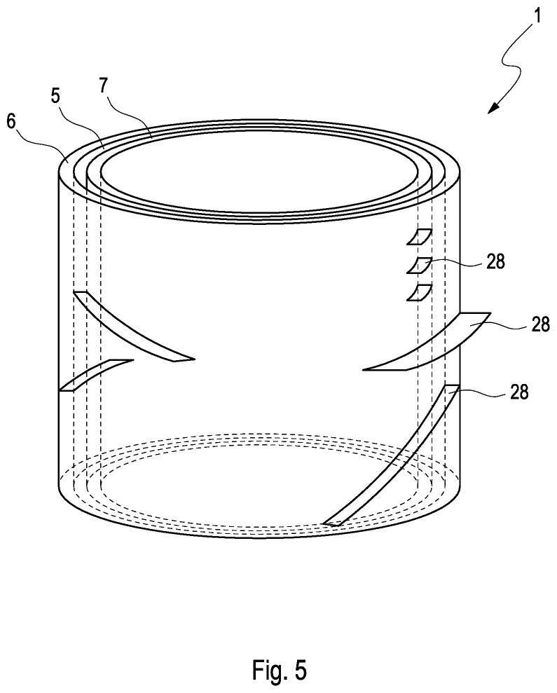

FIG. 5 shows a hollow cylindrical filter element 1 constructed from support body 5 and structural bodies 6, 7, in which the structural bodies 6, 7 are arranged coaxially, preferably concentrically with respect to one another. In the region of the support bodies 5, flow guidance elements 28, what are known as guide bodies/flaps 28, are integrated into the lattice structures 15 of the structural bodies 6, 7. These guide bodies 28 are printed inside or outside the lattice structures 15 of the structural bodies 6, 7 during the 3D printing process.

Such a guide body 28 positioned on the edge region of the lattice body 15 can guide the fluid to be filtered in a targeted manner due to its geometric shaping and positioning or to certain regions of the lattice body 15, so that the previously described optimum throughflow 8 and filtering effect of the filter element 1 is achieved. A circular swirling of the fluid in the form or manner of a cyclone may constitute one possible effect here, for example. During the throughflow 8 of the structural bodies 6, 7, the targeted steering of the fluid may also be achieved by means of guide bodies 28 that are arranged inside the lattice body 15 and shaped correspondingly. Also, these inner guide bodies 28 are also introduced or printed into the same directly during the 3D printing of the lattice body 15.

Furthermore, the guide bodies 28 can also be arranged both inside the lattice body 15 and between two or more lattice bodies 15. Thus, the fluid flowing in in a lattice body 15 can very effectively and quickly be guided into further lattice bodies 15 or distributed into the same by the overlapping arranged guide bodies 28. Also, the fluid can be steered in alternating directions and thus into different filter regions by a plurality of guide bodies 28 that are assigned to one another. To this end, the guide bodies 28 are designed as curved-surface, wound surfaces of increasing or decreasing size, wherein additional protruding or recessed mouldings may be present on the guide bodies 28 to support the guiding function of the fluid.

Instead of the flat guiding bodies 28, geometric solid bodies, for example in a cubic shape, may be introduced into the lattice bodies 15 and the fluid may flow around them as flow resistance. Here, swirling is created, which in turn influences the flow behaviour of the fluid in such a manner that the same is as a result steered in a targeted manner into certain regions of the filter element 1 and into the lattice bodies 15.

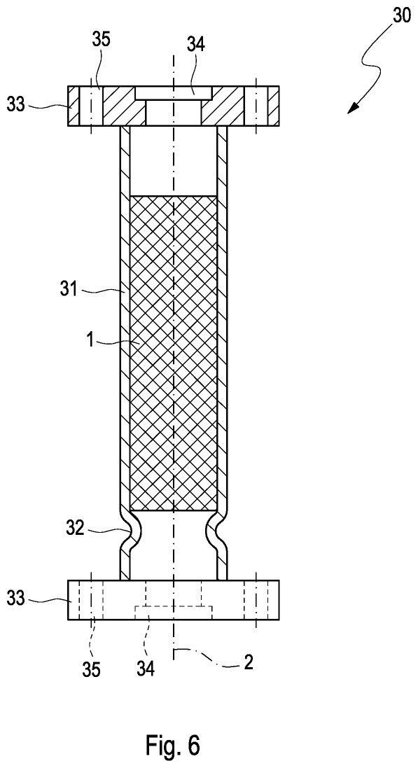

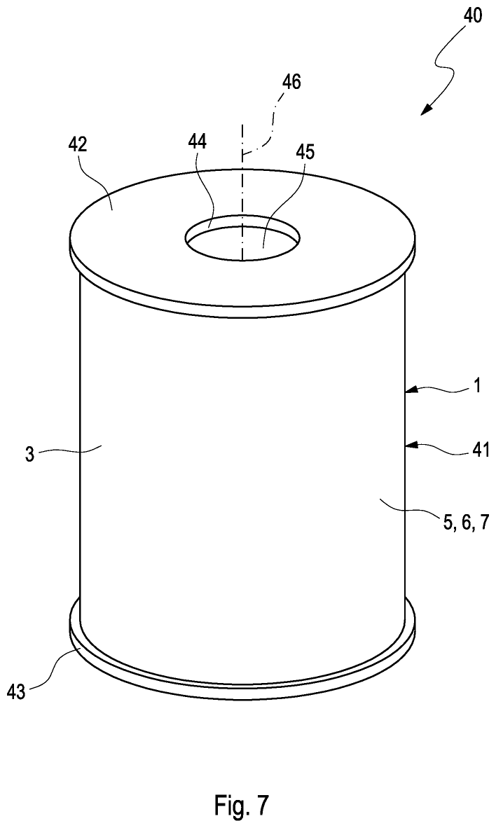

A 3D printed filter unit 30 with housing 31, flanges 33 and a filter element 1 is illustrated in FIG. 6. Here, during the 3D printing process, for example, the outermost structural body 6 is not printed as a lattice body 15 but rather as a solid body in the form of a housing wall 31. The housing 31 depicted in FIG. 6 substantially corresponds to the geometric shaping of the filter element 1 and is as such constructed solidly. Also, the housing 31 can be printed at the same time with the filter element 1 and as a one-piece component. Fastening flanges 33 are moulded at the ends of the housing 31, which are used for example for mounting the filter unit 30 on a machine. The flanges 33 are to this end realized with fastening holes 35 for mounting by means of suitable fastening means and have corresponding inlet and outlet openings 34 for the supply or drainage of the fluid. Both the fastening holes 35 and the inlet and outlet openings 34 are correspondingly moulded during the 3D printing method. In this manner, a complete filter unit 30 with filter element 1, housing 31 and fastening flanges 33 can be used and replaced as a completely printed design. Here, the housing 31 advantageously consists of a material with greater strength, which is created during the printing process by means of correspondingly suitable filaments. Furthermore, it is conceivable that corresponding filler materials are supplied to the filament used here to increase the strength.

One possible further embodiment consists in producing the housing 31 as a separate component without a filter element 1 by means of a 3D printing method. In this case, the filter element 1 is introduced and positioned in the housing 31 at a later time.

For positioning, a limit stop 32 or an insertion boundary 32 can be moulded in or on the housing 31 during the 3D printing process. The filter element 1 that is pushed in can be fixed in the housing 31, wherein the flange 33 can here also be used as a fixing from the insertion side. The fastening flanges 33 are also here attached to the housing 31 again, wherein a flange for mounting the filter element 1 is designed to be detachable. Instead of the printed housing 31, the previously produced filter element 1 can of course be pushed into a customary housing 31 that is present, wherein instead of the housing 31, a suitable position in a pipeline can also be used. Thus, it is for example possible to be able to use such filter elements 1 at virtually any desired position in a pipe system of a machine/motor.

This detachable flange 33 is subsequently connected to the housing 31 by means of a suitable connection such that it can be detached again or fixedly. The particular advantage for such a 3D printed housing 31 of a filter unit 30 consists in it being possible for the housing 31 to deviate in terms of its shape and dimensions from symmetrical shapes, and complex housings 31 with frequently changing shape progressions can be realized. The filter elements 1 to be used here correspondingly correspond to this housing shape. Specifically in the case of these filter elements 1 with shapes that change multiple times, the guide bodies 28 described in FIG. 5 are of particular interest, so that all important regions of the filter element 1 can be flown through effectively.

In principle, the respective structural body 6, 7 and the support body 5 can be 3D printed from various materials and/or material compositions. In this case, the respective structural body 6, 7 and the support body 5 can in each case be 3D printed from plastic and/or plastic material.

Preferred is an embodiment, in which the structure of the support body 5 has a cell structure 10, which has passages 12 formed by cells. In this case, the cells are formed using bar-shaped cell rods of the cell structure 10. Preferably, the meshes/pores 17 of the respective structural body 6, 7 are smaller than the cells or the passages 12 of the support body 5. For example, the cells or the passages 12 of the support body 5 can be at least twice or five-times or ten-times larger than the meshes/pores 17 of the respective structural body 6, 7.

Furthermore, it may be provided that the lattice rods 16 of the lattice structure 15 of the respective structural body 6, 7 have a smaller cross section than cell rods of the cell structure 10 of the support body 5. For example, the cross section of the cell rods of the cell structure 10 of the support body 5 may be at least twice or five-times or ten-times larger than the cross section of the lattice rods 16 of the lattice structure 15 of the respective structural body 6, 7.

As explained above, a portion of the lattice rods 16 of the lattice structure 15 penetrate into the passages 12 of the cell structure 10 or through the same. Preferably, a portion of the lattice rods 16 of the lattice structure 15 penetrate in such a manner into the passages 12 of the cell structure 10 or in such a manner through the same, that the lattice structure 15 is positively fastened on the cell structure 10. A further additional fixing by fusion connections can then be dispensed with.

According to FIG. 7, the filter element 1 can be configured as a ring filter element 40, in which the respective structural body 6, 7 and the support body 5 form an annular ring filter body 41. In other words, in this case, the filter element body 3 is configured annularly and forms the said ring filter body 41. The filter element 1 or the ring filter element 40 additionally has two end plates 42, 43, which are respectively arranged at an axial end of the ring filter body 41. The upper end plate 42 in FIG. 7 is configured as an open end plate and accordingly has a central passage opening 44, which is open towards an interior 45 surrounded by the ring filter body 41. The lower end plate 43 in FIG. 7 may likewise be configured as an open end plate. Alternatively, the lower end plate 43 may also be configured as a closed end plate which axially closes the interior 45. At least one of the end plates 42, 43 can be printed onto the ring filter body 41 by means of 3D printing.

FIG. 7 accordingly shows a ring filter element 40, particularly for a filter unit 30 for filtering a fluid, wherein the ring filter element 40 is equipped with an annular ring filter body 41, which is formed by a filter element 1 of the previously described type, and with two end plates 42, 43, which are respectively arranged at an axial end of the ring filter body 41. The ring filter body 41 is flowed through radially during the operation of the ring filter element 40. Cleaned fluid can be drained or uncleaned fluid can be supplied through the throughflow opening 44—depending on the direction of throughflow. The axial direction of the ring filter element 40 is defined by the central longitudinal axis 46 thereof.

1. A filter element for a filter unit for filtering a fluid, comprising:
a filter element body through which the fluid is flowable, the filter element body including at least one structural body and a support body;
the the at least one structural body having a filter structure which is permeable for the fluid, the filter structure having a plurality of meshes/pores;
the filter structure structured as a three-dimensionally interlinked lattice structure, the three-dimensionally interlinked lattice structure having a repeating regularity;
the plurality of meshes/pores formed as a plurality of clear spaces by a plurality of lattice rods that are securely connected to one another;
wherein the support body includes a support structure that is permeable for the fluid;
wherein the at least one structural body and the support body are each produced via a 3D printing method; and
wherein the at least one structural body and the support body are 3D printed from at least one of various materials and material compositions.

2. (canceled)

3. The filter element according to claim 1, wherein the at least one structural body and the support body are each 3D printed from at least one of a plastic and a plastic material.

4. The filter element according to claim 1, wherein:
the support structure of the support body has a cell structure, which has a plurality of passages formed by a plurality of cells; and
the plurality of meshes/pores of the at least one structural body are smaller than at least one of the plurality of cells and the plurality of passages of the support body.

5. The filter element according to claim 1, wherein:
the support structure of the support body has a cell structure, which has a plurality of passages formed by a plurality of cells; and
the plurality of lattice rods of the lattice structure of the at least one structural body have a smaller cross section than a plurality of cell rods of the cell structure of the support body.

6. The filter element according to claim 4, wherein at least one of the plurality of cells and the plurality of passages of the support body are at least one of at least two-times, five-times and ten-times larger than the plurality of meshes/pores of the at least one structural body.

7. The filter element according to claim 5, wherein the cross section of the plurality of cell rods of the cell structure of the support body are at least one of at least two-times, five-times and ten-times larger than the cross section of the plurality of lattice rods of the lattice structure of the at least one structural body.

8. The filter element according to claim 1, wherein:
the support structure of the support body has a cell structure, which has a plurality of passages formed by a plurality of cells; and
a portion of the plurality of lattice rods of the lattice structure penetrate at least one of (i) into the plurality of passages of the cell structure and (ii) through the plurality of passages of the cell structure.

9. The filter element according to claim 8, wherein the portion of the plurality of lattice rods of the lattice structure penetrate at least one of (i) into the plurality of passages of the cell structure and (ii) through the plurality of passages of the cell structure such that the lattice structure is positively fastened on the cell structure.

10. The filter element according to claim 4, wherein:
the at least one structural body includes a single structural body;
the cell structure of the structural body is arranged in an interior of the lattice structure of the structural body; and
at least a few of the plurality of lattice rods penetrate the plurality of cells.

11. The filter element according to claim 4, wherein:
the at least one structural body includes two structural bodies arranged coaxially inside one another;
the support body is arranged between the two structural bodies; and
at least a few of the plurality of lattice rods penetrate the plurality of cells of the cell structure of the support body and connect the two structural bodies to one another.

12. The filter element according to claim 1, wherein:
the at least one structural body and the support body are of hollow cylindrical configuration and arranged coaxially inside one another; and
the at least one structural body and the support body are arranged approximately parallel to one another.

13. The filter element according to claim 1, wherein:
the at least one structural body is securely connected to the support body; and
the secure connection between the at least one structural body and the support body is formed via a materially-bonded connection.

14. The filter element according to claim 1, wherein:
the at least one structural body includes two structural bodies, the two structural bodies including a first structural body and a second structural body;
a plurality of further structural bodies are arranged on the two structural bodies, which are arranged coaxially inside one another;
an inner region of a first further structural body of the plurality of further structural bodies is in direct contact with an outer region of the first structural body and is securely connected thereto; and
an outer region of a second further structural body of the plurality of further structural bodies is in direct contact with an inner region of the second structural body and is securely connected thereto.

15. The filter element according to claim 14, wherein the two structural bodies penetrate one another in an overlapping manner over a plurality of outer regions and a plurality of inner regions thereof at least in certain regions.

16.-17. (canceled)

18. The filter element according to claim 1, wherein:
a plurality of materials/substances that are reactive or act catalytically on the fluid are embedded inside the plurality of meshes/pores formed by the plurality of interlinked and securely connected lattice rods; and
the fluid to be filtered has a coalescent effect to form particles that are precipitable.

19. The filter element according to claim 1, wherein the plurality of meshes/pores of the support body formed by the plurality of connected lattice rods each have an edge length that is at least one of:
0.05 mm to 15 mm for the filtration of liquid fluids; and
0.1 mm to 40 mm for the filtration of gaseous fluids.

20. The filter element according to claim 1, wherein:
the at least one structural body includes a plurality of structural bodies;
a plurality of adjacent structural bodies of the plurality of structural bodies have different interlinked lattice structures from one another;
the plurality of adjacent structural bodies have different material properties of the interlinked lattice structures from one another; and
the interlinked lattice structures that are different from one another and the material properties of the interlinked lattice structures that are different from one another change at least one of abruptly and continuously.

21. The filter element according to claim 1, wherein the at least one structural body and the support body are each structured from one piece.

22. The filter element according to claim 1, wherein:
a plurality of flow guidance elements/guide bodies are arranged at least one of on and inside the at least one structural body and the support body;
the plurality of flow guidance elements/guide bodies are arranged in an overlapping manner on at least one of a plurality of further structural bodies and the support body;
the plurality of flow guidance elements/guide bodies have at least one of a planar shape, a curved shape, and a wound shape; and
the plurality of flow guidance elements/guide bodies change at least one of abruptly and continuously in terms of shaping.

23. The filter element according to claim 1, wherein:
the filter element is configured as a ring filter element, in which the at least one structural body and the support body form at least one of an annular ring filter body and at least one annular part of the ring filter body; and
the filter element further comprises two end plates respectively arranged at an axial end of the ring filter body.

24. A ring filter element for a filter unit for filtering a fluid, comprising:
an annular ring filter body including a filter element;
two end plates respectively arranged at an axial end of the ring filter body;
the filter element including:
a filter element body through which the fluid is flowable, the filter element body including at least one structural body and a support body;
the at least one structural body having a filter structure which is permeable for the fluid, the filter structure having a plurality of meshes/pores;
the filter structure structured as a three-dimensionally interlinked lattice structure, the three-dimensionally interlinked lattice structure having a repeating regularity;
the plurality of meshes/pores formed as a plurality of clear spaces by a plurality of lattice rods that are securely connected to one another;
the support body including a support structure that is permeable for the fluid;
wherein the at least one structural body and the support body are each produced via a 3D printing method; and
wherein the at least one structural body and the support body are 3D printed from at least one of various materials and material compositions.

25. A filter unit comprising a housing and a filter element inserted into the housing, wherein:
the filter element includes:
a filter element body through which the fluid is flowable, the filter element body including at least one structural body and a support body;
the at least one structural body having a filter structure which is permeable for the fluid, the filter structure having a plurality of meshes/pores;
the filter structure structured as a three-dimensionally interlinked lattice structure, the three-dimensionally interlinked lattice structure having a repeating regularity;
the plurality of meshes/pores formed as a plurality of clear spaces by a plurality of lattice rods that are securely connected to one another;
the support body including a support structure that is permeable for the fluid;
the at least one structural body and the support body are each produced via a 3D printing method; and
the at least one structural body and the support body are 3D printed from at least one of various materials and material compositions.
